(19) United States
(12) Patent Application Publication
(10) Pub. No.: US 2011/0193403 A1
(43) Pub. Date: Aug. 11, 2011

(54) Bicycle Spoke and Hub Assembly

(76) Inventor: Wu-Hui Chen, Yongjing Township (TW)

(21) Appl. No.: 12/917,023

(22) Filed: Nov. 1, 2010

(30) Foreign Application Priority Data
Feb. 11, 2010 (TW) 99104410
Feb. 11, 2010 (TW) 99203020

(51) Int. Cl. B60B 1/04; B60B 21/06

(52) U.S. Cl. 301/59; 301/57

(57) ABSTRACT

A bicycle spoke and hub assembly comprises a hub and a connected device. The hub includes a first end and a second end. The first end of the hub has an installing portion. The installing portion has an opening distal from the second end of the hub. The connected device includes a seat and at least one spoke extended from the seat. The seat and the spoke are made of one piece. The seat of the connected device is installed to the installing portion. The spoke includes a first portion integrally formed on the seat and at least two second portions installed to a rim. The stress applied on the spoke will be dissipated on the seat because the first portion is integrally formed on an outer surface of the seat. Stress concentration will not be caused between the seat and the spoke.

### BACKGROUND OF THE INVENTION

1. Field of the Invention

The present invention relates generally to a bicycle spoke and hub assembly.

2. Description of the Related Art

Taiwan Patent M246192 discloses a hub with spoke holes. Each spoke hole can be inserted by a spoke of a circular or rhombus cross section. Each spoke has two opposite ends including a first end installed to the spoke holes and a second end installed to a rim. Therefore, the hub and the rim are connected with each other via the spokes. The spokes are adapted for transferring the motive power of a hub, which is applied by a rider, to the rim so that the rim can be driven via the spokes. The spokes are also adapted for being a support between the hub and the rim and bearing the weight of frame and rider. However, the spoke is made of metal and is heavy due to the high density. Further, the spoke is apt to rust so as to increase the maintenance cost.

Referring to Taiwan patent M325932, it discloses a spoke structure. The spoke structure includes a plate made of composite material and a connecting set. The plate has a first end and a second end opposite to first end. The connecting set includes a first connecting element and a second connecting element. Each of the first and second connecting elements is made of metal and has a fixed portion. The fixed portions of first and second connecting elements are installed to the first and second end of the plate, respectively. The connecting set and the plate is steadily connected because that the fixed portion has a larger connecting area to increase the tension thereof.

One end of each spoke structure is inserted through the spoke hole and the head portion of the spoke structure abuts against one end of the spoke hole. The spoke structure produces a tensile force while the wheel rotates. A stress concentration is caused on the spoke hole where the head portion of the spoke structure abuts. The hub may be cracked because of the stress concentration. Moreover, the other end of each spoke structure connects to the rim so that the stress applied by the rim is transferred to the hub via the other end of each spoke. The distance of each spoke will be different with each other while accumulating a long period. Hence, the smoothness of operating the rim is affected.

The present invention is, therefore, intended to obviate or at least alleviate the problems encountered in the prior art.

### SUMMARY OF THE INVENTION

According to the present invention, the main purpose is to provide a bicycle spoke and hub assembly which comprises a hub and a connected device. The hub has two opposing ends including a first end and a second end. The first end of the hub has an installing portion. The installing portion has an opening distal from the second end of the hub. The connected device includes a seat and at least one spoke extended from the seat. The seat and the spoke are made of one piece. The seat of the connected device is installed to the installing portion. The spoke includes a first portion integrally formed on the seat and at least two second portions installed to a rim. The second portions are extended from the first portion. The stress applied on the spoke will be dissipated on the seat because the first portion is integrally formed on an outer surface of the seat. Stress concentration will not be caused between the seat and the spoke.

An advantage of the bicycle spoke and hub assembly according to the present invention is that stress applied on the spoke will be dissipated on the seat because the first portion is integrally formed on the outer surface of the seat.

Another advantage of the bicycle spoke and hub assembly according to the present invention is that each second portion is spaced from the other one; as a result, the second portions dissipate the stress applied on the rim.

Another advantage of the bicycle spoke and hub assembly according to the present invention is that each second portion and the first portion have a distance therebetween to keep the distance between the rim and the hub so that the smoothness of operating is improved.

A further advantage of the bicycle spoke and hub assembly according to the present invention is that each edge abuts against the related lateral face so that the hub can sustain shear force applied thereon.

Other advantages and features of the present invention will become apparent from the following description referring to the drawings.

### BRIEF DESCRIPTION OF THE DRAWINGS

FIG. 1 is a perspective view of a bicycle spoke and hub assembly according to a first embodiment of the present invention.

FIG. 2 is a partial, enlarged view of FIG. 1.

FIG. 3 is an exploded perspective view of the bicycle spoke and hub assembly of FIG. 2.

FIG. 4 is a partial, enlarged view of the bicycle spoke and hub assembly according to a second embodiment of the present invention.

FIG. 5 is an exploded perspective view of the bicycle spoke and hub assembly of FIG. 4.

FIG. 6 is another exploded perspective view of the bicycle spoke and hub assembly of FIG. 4.

FIG. 7 is a cross-section view taken along line 7-7 of FIG. 4.

FIG. 8 is a partial, enlarged view of the bicycle spoke and hub assembly according to a third embodiment of the present invention.

FIG. 9 is an exploded perspective view of the bicycle spoke and hub assembly of FIG. 8.

FIG. 10 is another exploded perspective view of the bicycle spoke and hub assembly of FIG. 8.

FIG. 11 is a cross-section view taken along line 11-11 of FIG. 8.

FIG. 12 is a partial, enlarged view of the bicycle spoke and hub assembly according to a fourth embodiment of the present invention.

FIG. 13 is an exploded perspective view of the bicycle spoke and hub assembly of FIG. 12.

FIG. 14 is another exploded perspective view of the bicycle spoke and hub assembly of FIG. 12.

FIG. 15 is a cross-section view taken along line 15-15 of FIG. 12.

FIG. 16 is a partial, enlarged view of the bicycle spoke and hub assembly according to a fifth embodiment of the present invention.

FIG. 17 is a partial, enlarged view of the bicycle spoke and hub assembly according to a sixth embodiment of the present invention.

FIG. 18 is an exploded perspective view of the bicycle spoke and hub assembly of FIG. 17.

FIG. 19 is another exploded perspective view of the bicycle spoke and hub assembly of FIG. 17.

### DETAILED DESCRIPTION OF THE PREFERRED EMBODIMENT

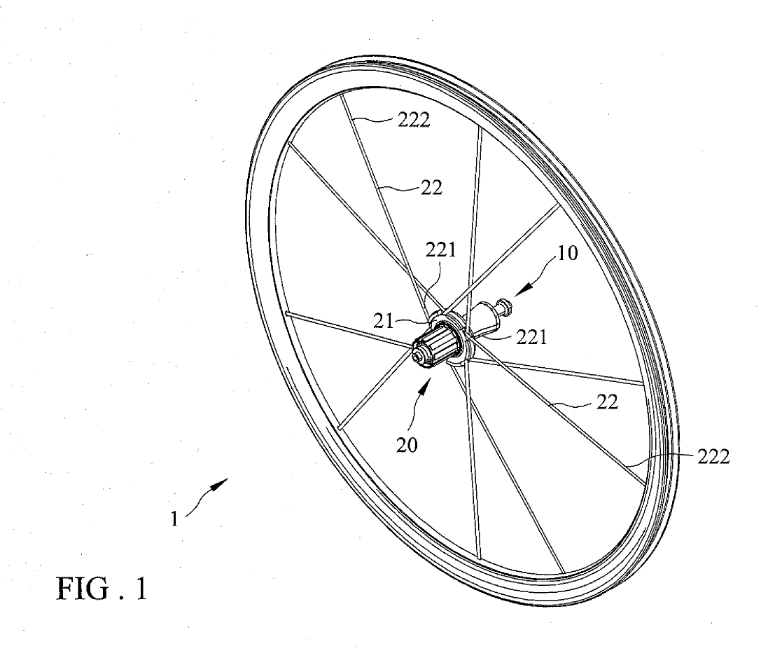

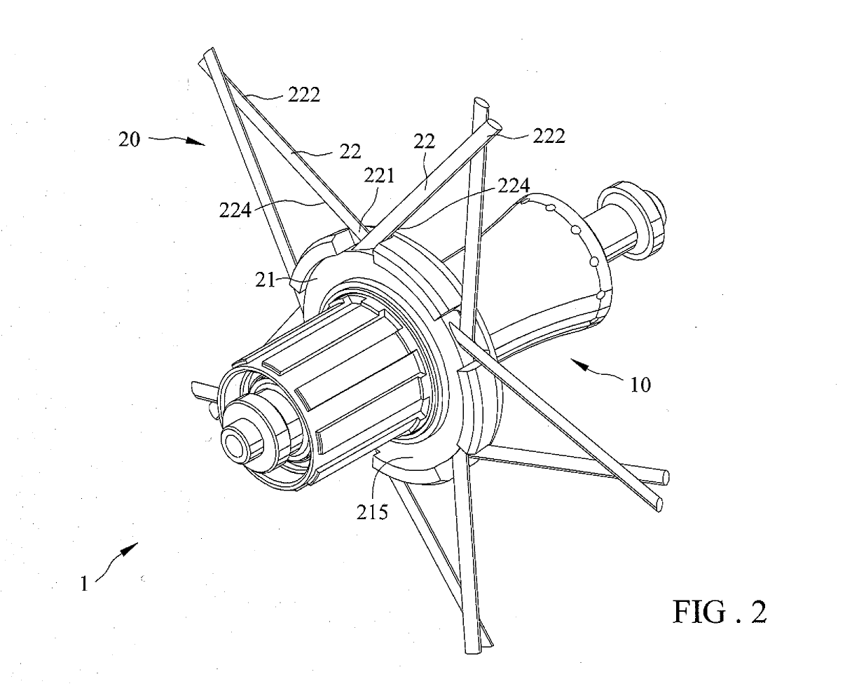

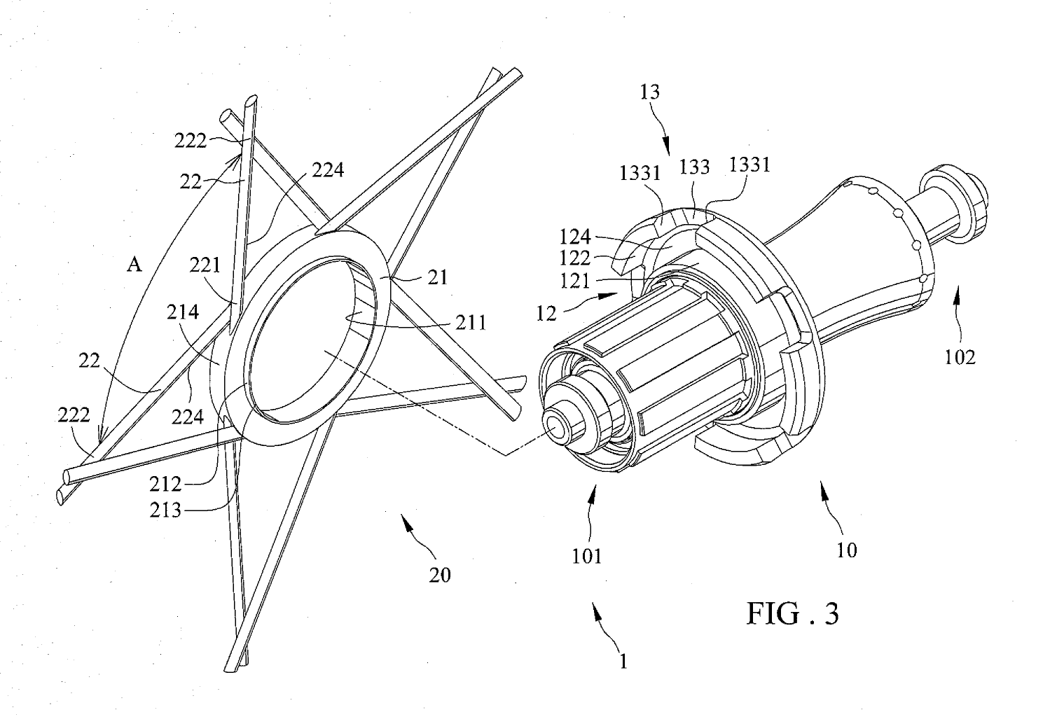

Referring to FIG. 1 to FIG. 3, there is shown a bicycle spoke and hub assembly 1 according to a first embodiment of the present invention, the bicycle spoke and hub assembly 1 comprises a hub 10 and a connected device 20.

The hub 10 has two opposing ends including a first end 101 and a second end 102. The first end 101 of the hub 10 has an installing portion 12 and a retaining portion 13 formed thereon. Preferably, the installing portion 12 is a compartment. The installing portion 12 extends alone a longitudinal axis of the hub 10 and has an opening distal from the second end 102 of the hub 10. The installing portion 12 includes a first inner wall 121, a second inner wall 122 and a bottom wall 124 extended between the first and second inner walls 121, 122. The bottom wall 124 of the installing portion 12 is perpendicular to the longitudinal axis of the hub 10. The installing portion 12 is delimited by the first inner wall 121, the second inner wall 122 and the bottom wall 124. The retaining portion 13 is disposed on the outer periphery of the hub 10 and is in communication with the installing portion 12. The retaining portion 13 includes at least one recess 133, and the recess 133 is in communication with the installing portion 12 and has two lateral faces 1331. Preferably, each lateral face 1331 is perpendicular to the bottom wall 124.

The connected device 20 can be made of composite material or aluminum. The connected device 20 includes a seat 21 and at least one spoke 22 extended from the seat 21. The seat 21 and the spoke 22 are made of one piece. Preferably, the seat 21 is a bushing having a mounting portion 211 extending therethrough. The seat 21 of the connected device 20 is installed to the installing portion 12 in an adhesive manner so as to keep the seat 21 from disengaging from the installing portion 12. The mounting portion 211 is mounted on the first inner wall 121 of the installing portion 12. The second inner wall 122 of the installing portion 12 is mounted on an outer surface 214 of the seat 21. The seat 21 is restricted between the first inner wall 121 and the second inner wall 122 so as to prevent the seat 21 from moving with respect to the hub 10. The seat 21 has a protruded area 212 extended toward the bottom wall 124 of the hub 10 and disposed in the installing portion 12. The protruded area 212 has a proximal face 213 adjacent to the bottom wall 124 of the installing portion 12 and abutted against the bottom wall 124 of the installing portion 12 so as to prevent the seat 21 from moving toward the second end 102 of the hub 10. The seat 21 further has a distal face 215 distal from the proximal face 213. Preferably, the distal face 215 is parallel to the proximal face 213.

The spoke 22 includes a first portion 221 integrally formed on the seat 21 and at least two second portions 222 installed to a rim (not labeled). The second portions 222 are extended from the first portion 221. The stress applied on the spoke 22 will be dissipated on the seat 21 because the first portion 221 is integrally formed on the outer surface 214 of the seat 21. The stress concentration will not be caused between the seat 21 and the spoke 22. Two of the second portions 222 and the first portion 221 have an angle A so that the spoke 22 is substantially V-shaped. Each second portion 222 is spaced from the other one; as a result, the second portions 222 dissipate the stress applied on the rim. Further, each second portion 222 and the first portion 221 have a distance therebetween to keep the distance between the rim and the hub 10 so that the smoothness of operating is improved. The spoke 22 inserts through the recess 133 of the retaining portion 13 and is retained via the recess 133. The spoke 22 has two edges 224 corresponding to the lateral faces 1331, respectively. Each edge 224 abuts against the related lateral face 1331 so that the hub 10 can sustain the shear force applied thereon. Preferably, the connected device 20 includes a plurality of spokes 22 equally distributed on the outer surface 214 of the seat 21. All the spokes 22 and the seat 21 are integrally formed as a single to dissipate the stress applied on the seat 21.

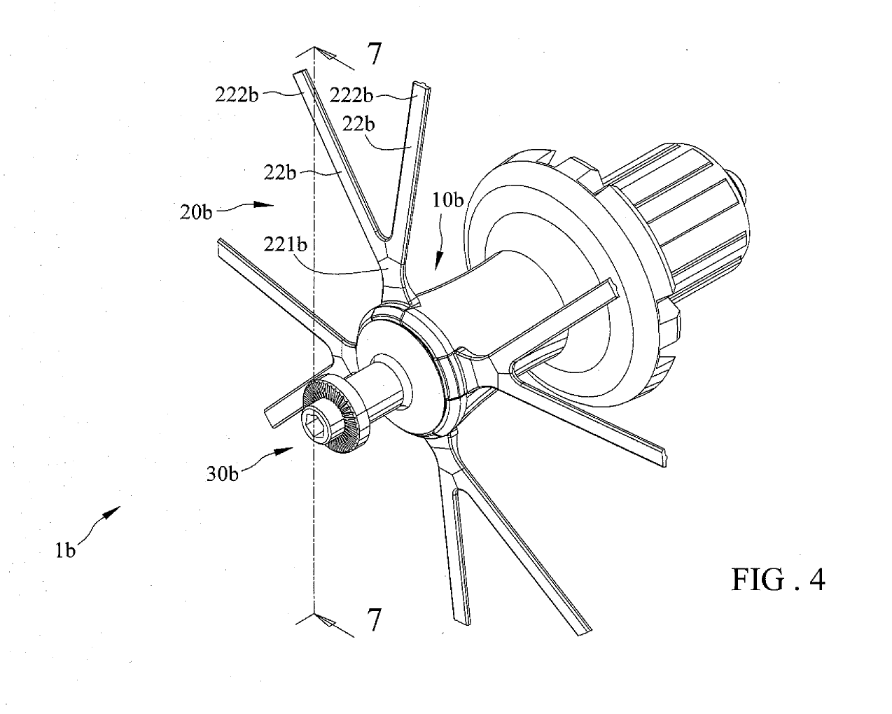

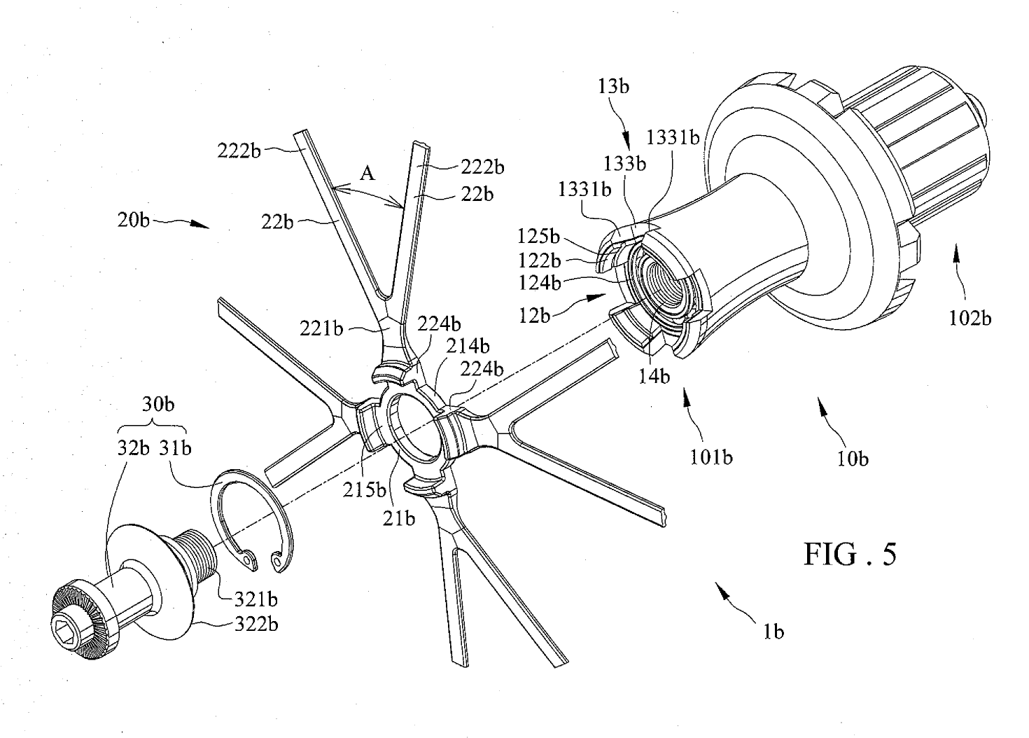

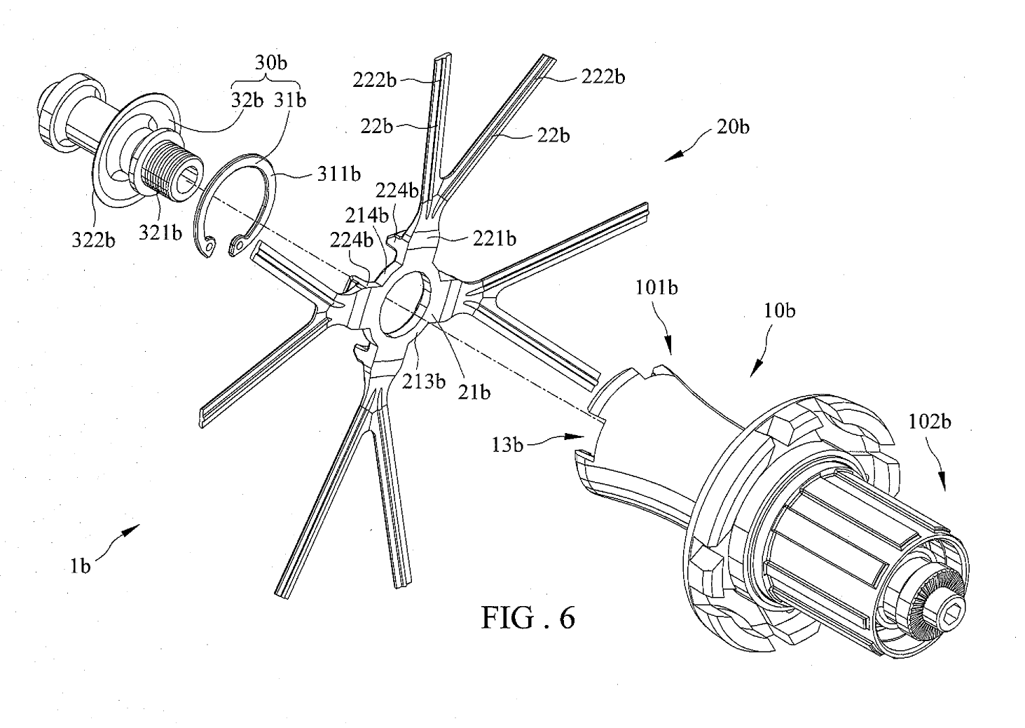

Referring to FIG. 4 to FIG. 6, there is shown a bicycle spoke and hub assembly 1b according to a second embodiment of the present invention. The second embodiment is like the first embodiment except that the bicycle spoke and hub assembly 1b further comprises a locking device 30b installed to the first end 101b of the hub 10b. Preferably, the first end 101b of the hub 10b has a holding portion 14b formed thereon. The holding portion 14b extends toward the second end 102b of the hub 10b and alone the longitudinal axis of the hub 10b. The second inner wall 122b of the installing portion 12b has a limiting portion 125b formed thereon, in a preferred form, the limiting portion 125b is a groove. The seat 21b has a proximal face 213b adjacent to the bottom wall 124b of the installing portion 12b. The locking device 30b includes a positioning element 31 and a fastener 32. The positioning element 31b has a first face 311b adjacent to the bottom wall 124b of the installing portion 12b. Preferably, the holding portion 14b is a screw hole and the fastener 32b is a screw. The fastener 32b has a thread portion 321b on one end thereof and a flange 322b on the other end thereof distal from the thread portion 321b. The thread portion 321b corresponds to the holding portion 14b. The flange 322b can prevent dust falling into the installing portion 12b.

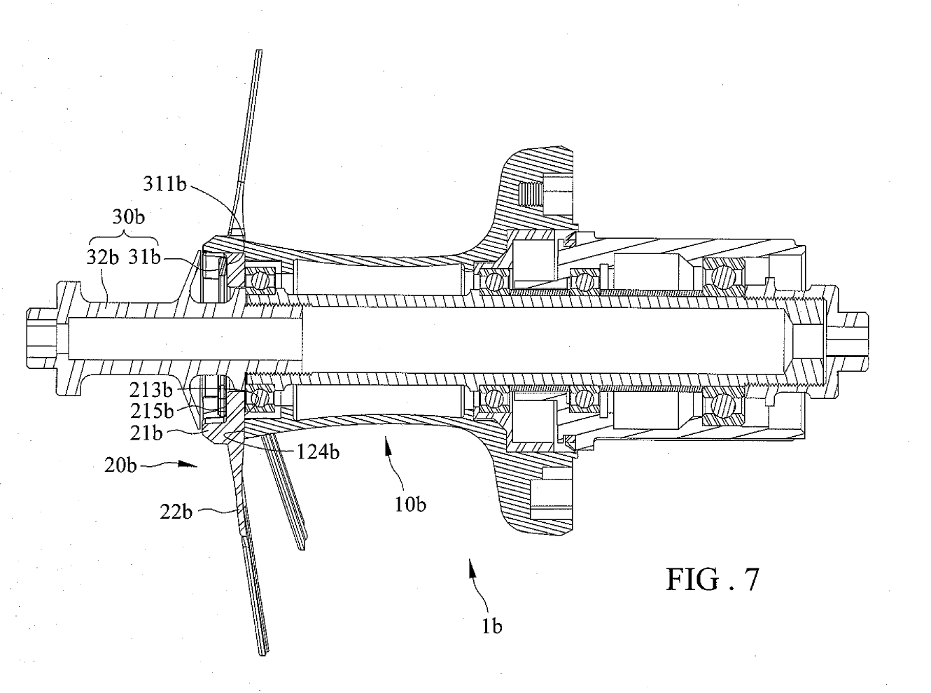

Referring to FIG. 7, the mounting portion 211b is mounted on the first inner wall 121b of the installing portion 12b. The second inner wall 122b of the installing portion 12b is mounted on an outer surface 214b of the seat 21b. The seat 21b is restricted between the first inner wall 121b and the second inner wall 122b so as to prevent the seat 21b from moving with respect to the hub 10b. The proximal face 213b is abutted against the bottom wall 124b of the installing portion 12b so as to prevent the seat 21b from moving toward the second end 102b of the hub 10b. The positioning element 31b is installed to the limiting portion 125b of the installing portion 12b. The first face 311b of the positioning element 31b abuts against the distal face 215b of the seat 21b so as to prevent the seat 21b disengaging from the installing portion 12b. The fastener 32b is installed to the holding portion 14b via the thread portion 321b.

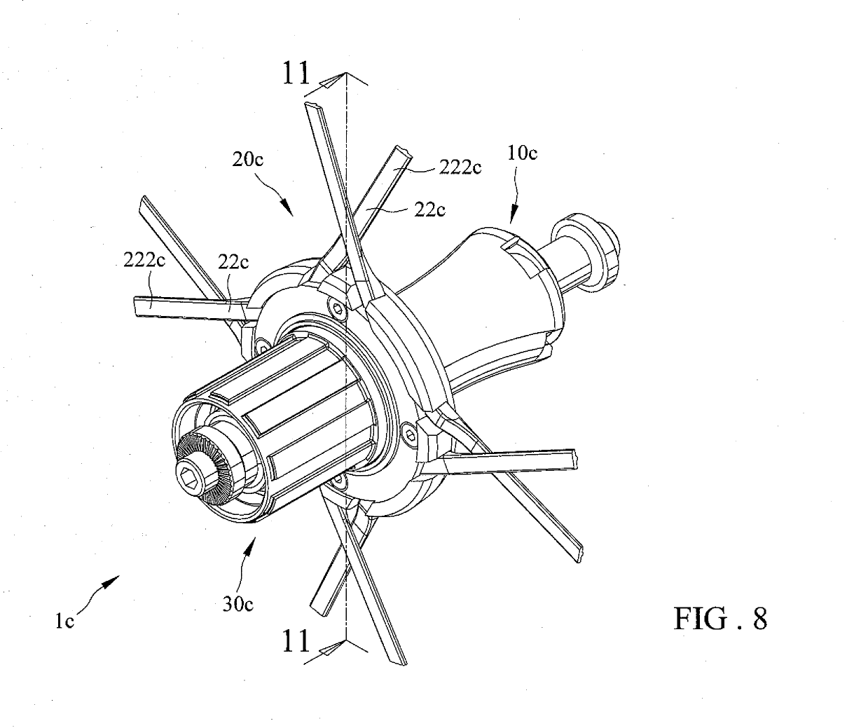

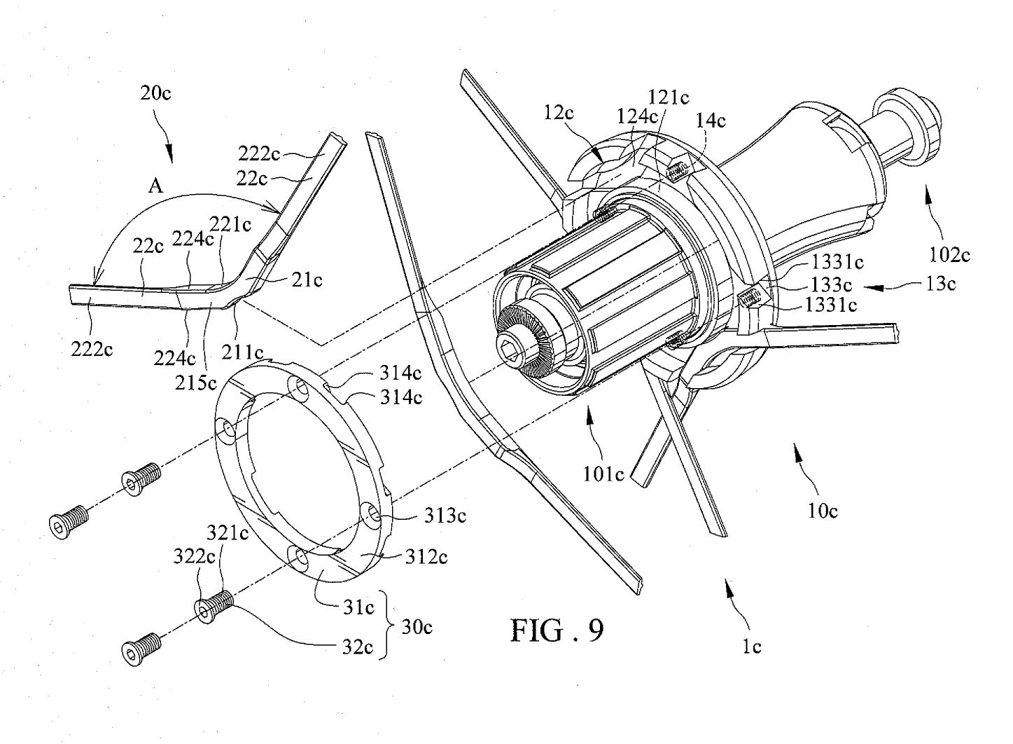

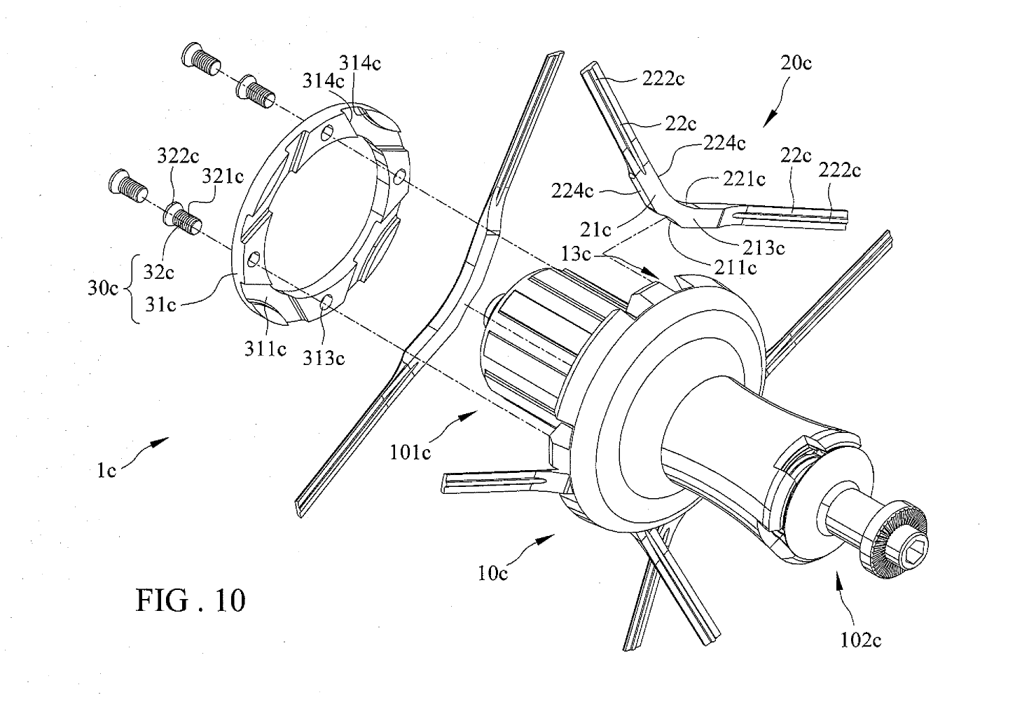

Referring to FIG. 8 to FIG. 10, there is shown a bicycle spoke and hub assembly 1c according to a third embodiment of the present invention. The third embodiment is like the first embodiment except that the bicycle spoke and hub assembly 1c comprises a plurality of connected device 20c and a locking device 30c. The bottom wall 124c of the installing portion 12c has at least one holding portion 14c formed thereon. The holding portion 14c extends toward the second end 102c of the hub 10c and alone the longitudinal axis of the hub 10c. Each connected device 20c includes a seat 21c and a spoke 22c integrally formed on the seat 21c. The seat 21c is substantially arched and has a proximal face adjacent to the bottom wall 124c of the installing portion 12c. The locking device 30c includes a positioning element 31c and a fastener 32c. The positioning element 31c has a first face 311c adjacent to the bottom wall 124c of the installing portion 12c and a second face 312c opposite to the first face 311c. The first face 311c is parallel to the second face 312c. The positioning element 31c further includes at least one through hole 313c and at least two retaining walls 314c. The through hole 313c extends from the first face 311c to the second face 312c and corresponds to the holding portion 14c. The retaining walls 314c are formed on the first face 311c of the positioning element 31c and correspond to the edges 224c of the spoke 22c, respectively. Preferably, the holding portion 14c is a screw hole and the fastener 32c is a screw. The fastener 32c has a thread portion 321c on one end thereof and a flange 322c on the other end thereof distal from the thread portion 321c. The thread portion 321c corresponds to the holding portion 14c. The flange 322c is adapted for abutting the second face 312c of the positioning element 31c. The retaining wall 314c is perpendicular to the first face 311. Each edge 224c abuts against the related retaining wall 314c so that the hub 10c can sustain the shear force applied thereon.

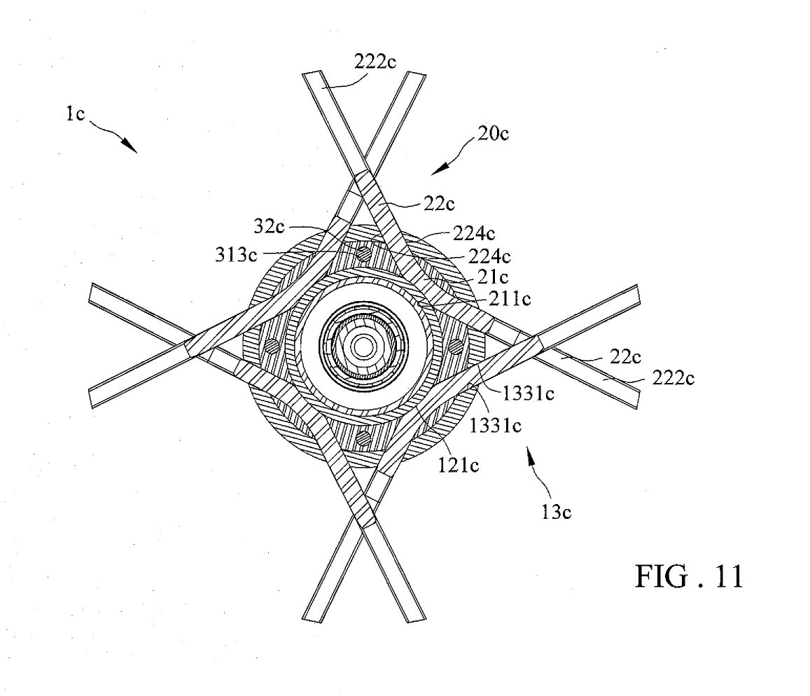

Referring to FIG. 11c, the connected devices 20c are disposed in the installing portion 12c, and the mounting portion 211c of the seat 21c abuts the first inner wall 121c of the hub 10. The spoke 22c inserts through the recess 133c of the retaining portion 13c and is retained via the recess 133c. The proximal face 213c is abutted against the bottom wall 124c of the installing portion 12c so as to prevent the seat 21c from moving toward the second end 102c of the hub 10c. The positioning element 31c is installed to the installing portion 12c. The first face 311c of the positioning element 31c abuts against the distal face 215c of the seat 21c so as to prevent the seat 21c disengaging from the installing portion 12c. The fastener 32c is installed to the holding portion 14c via the thread portion 321c. In addition, the flange 322c abuts the second face 312c of the positioning element 31c so as to prevent the positioning element 31c from disengaging from the installing portion 12c.

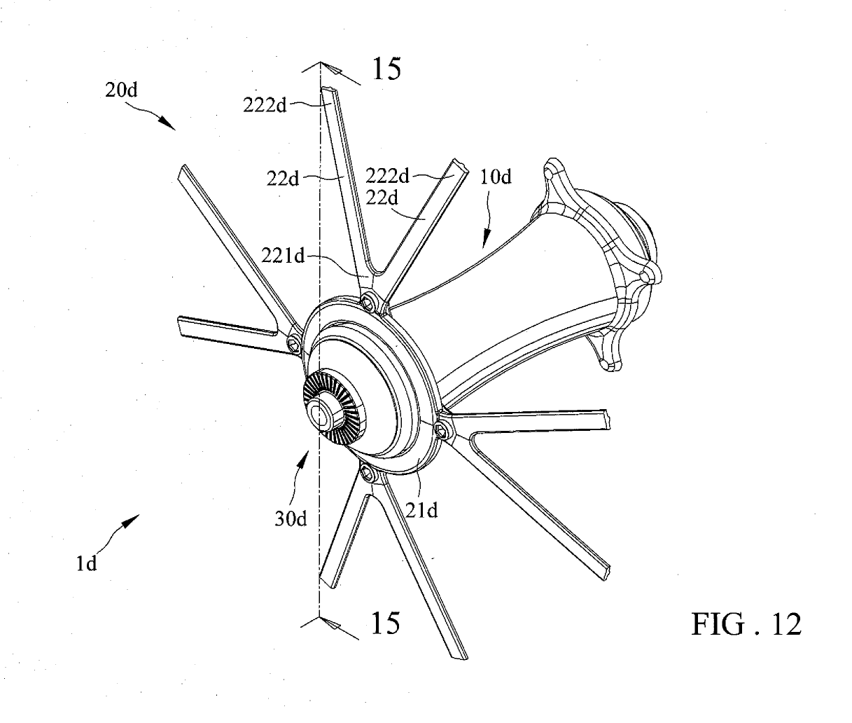

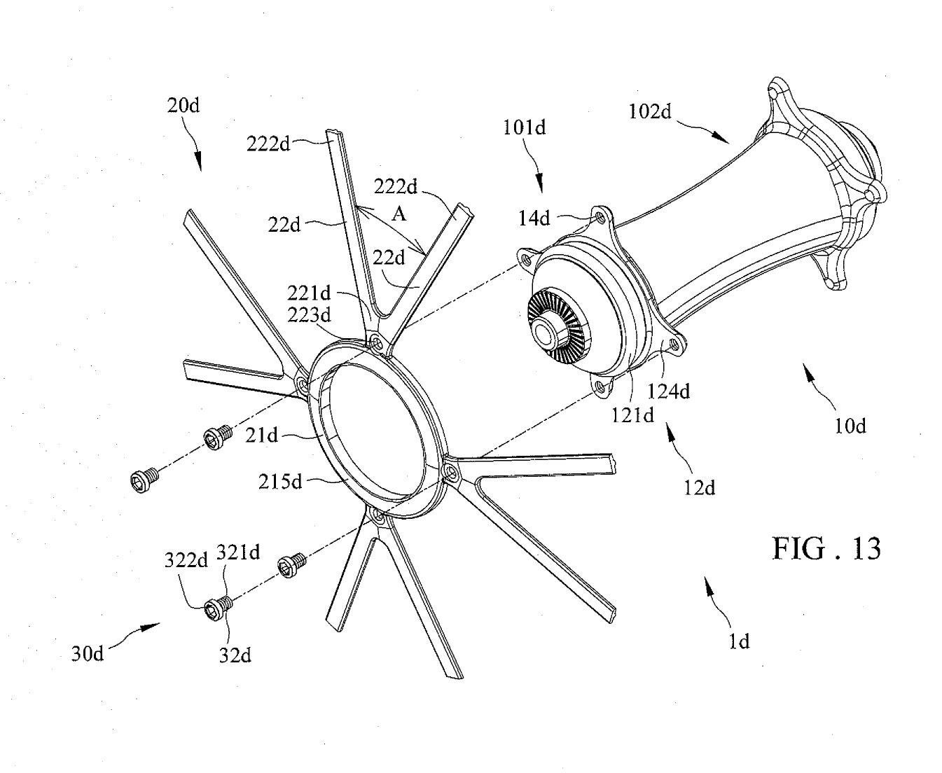

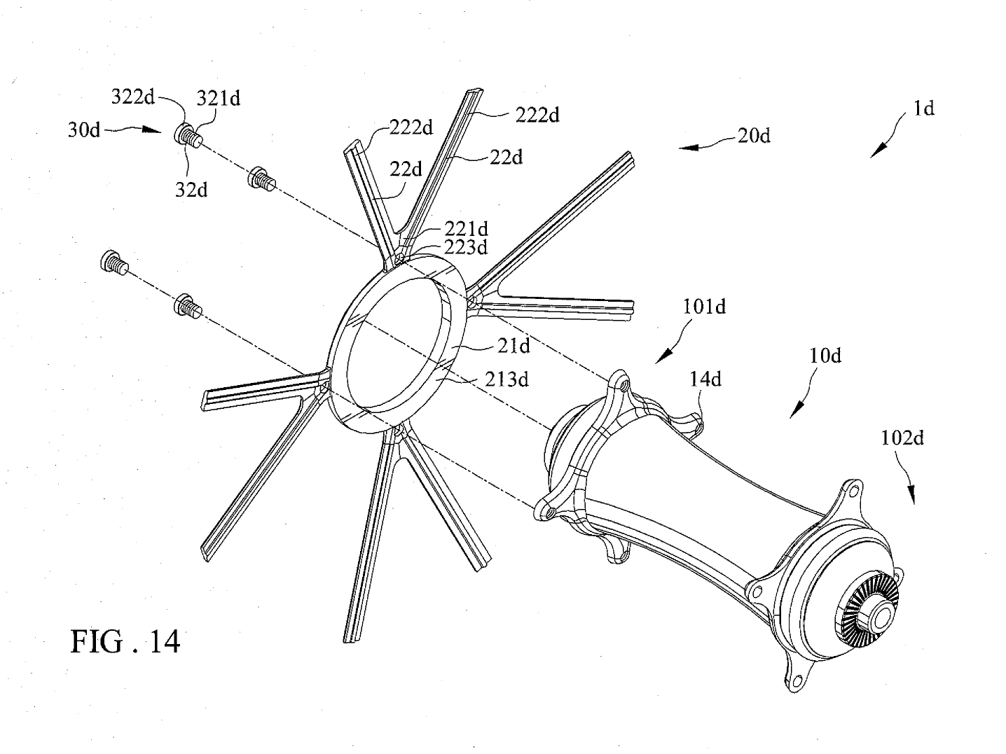

Referring to FIG. 12 to FIG. 14, there is shown a bicycle spoke and hub assembly 1d according to a fourth embodiment of the present invention. The fourth embodiment is like the first embodiment except that the bicycle spoke and hub assembly 1d further comprises a locking device 30d. The first portion 221d of the spoke 22d has an aperture 223d formed thereon. The bottom wall 124d of the installing portion 12d has a holding portion 14d formed thereon. The holding portion 14d corresponds to the aperture 223d. The holding portion 14d extends toward the second end 102d of the hub 10d and alone the longitudinal axis of the hub 10d. The seat 21d has a proximal face 213d adjacent to the bottom wall 124d of the installing portion 12d. The locking device 30d includes a fastener 32d corresponding to the holding portion 14d. Preferably, the holding portion 14d is a screw hole and the fastener 32d is a screw. The fastener 32d has a thread portion 321d on one end thereof and a flange 322d on the other end thereof distal from the thread portion 321d. The thread portion 321d corresponds to the holding portion 14d. The flange 322d is adapted for abutting the first portion 221d of the spoke 22d. Preferably, the connected device 20d has four apertures 223d, the installing portion 12d has four holding portions 14d corresponding to the four apertures 223d, and the locking device 30d has four fasteners 32d.

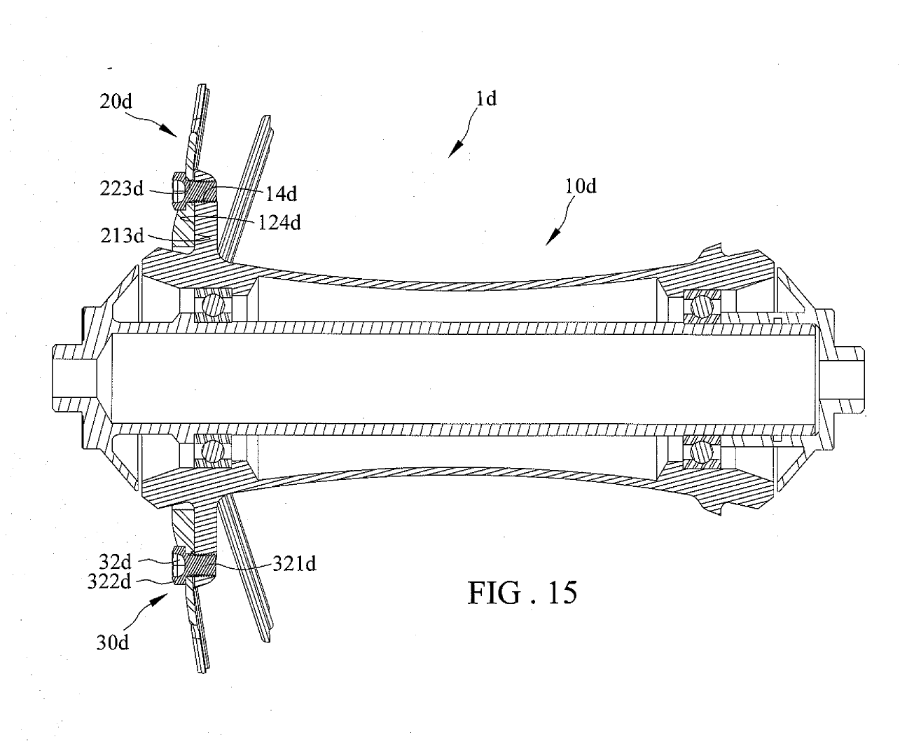

Referring to FIG. 15, the seat 21d of the connected device 20d is installed to the installing portion 12d. The proximal face 213d is abutted against the bottom wall 124d of the installing portion 12d so as to prevent the seat 21d from moving toward the second end 102d of the hub 10d. The fastener 32d is installed to the holding portion 14d via the thread portion 321d.

In addition, the flange 322d abuts the first portion 221d of the spoke 22d so as to prevent the connected device 20d from disengaging from the installing portion 12d.

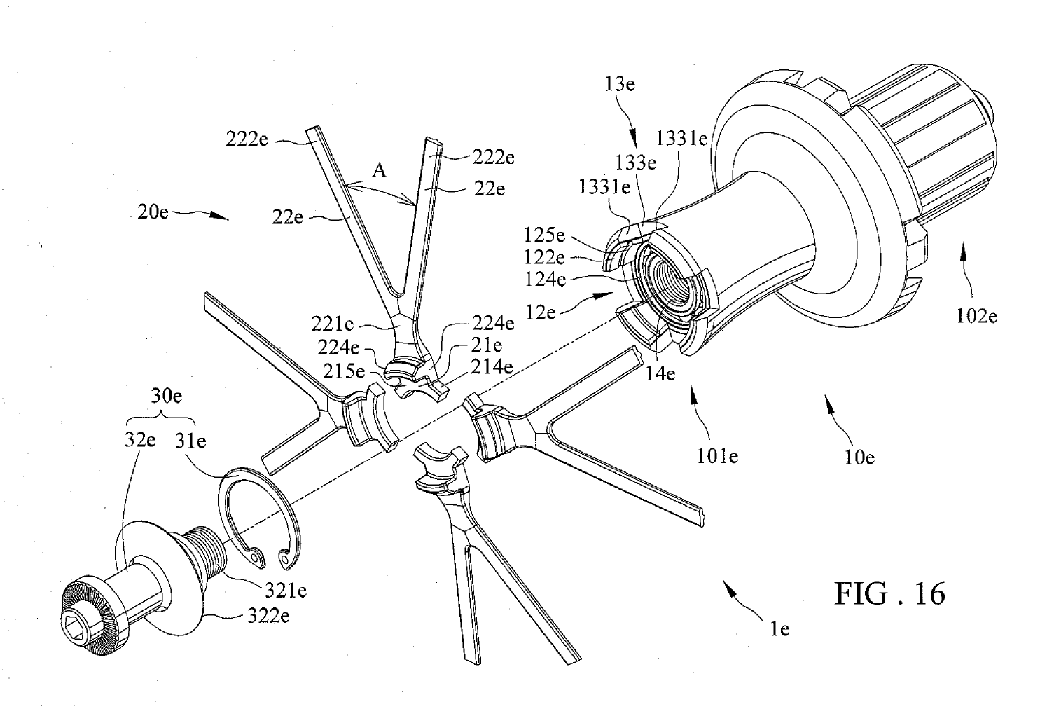

Referring to FIG. 16, there is shown a bicycle spoke and hub assembly 1e according to a fifth embodiment of the present invention. The fifth embodiment is like the first embodiment except that the bicycle spoke and hub assembly 1e comprises a plurality of connected device 20e. The spoke 22e and the seat 21e of each connected device 20e are integrally formed. The seat 21e of each connected device 20e is substantially arched. Preferably, the seats 21e are abutted with each other and are installed to the installing portion 12e jointly.

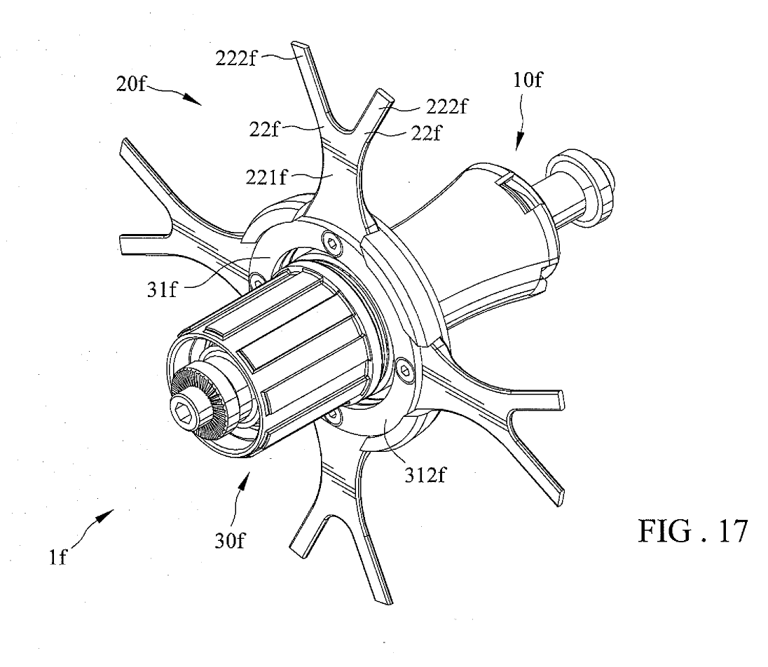

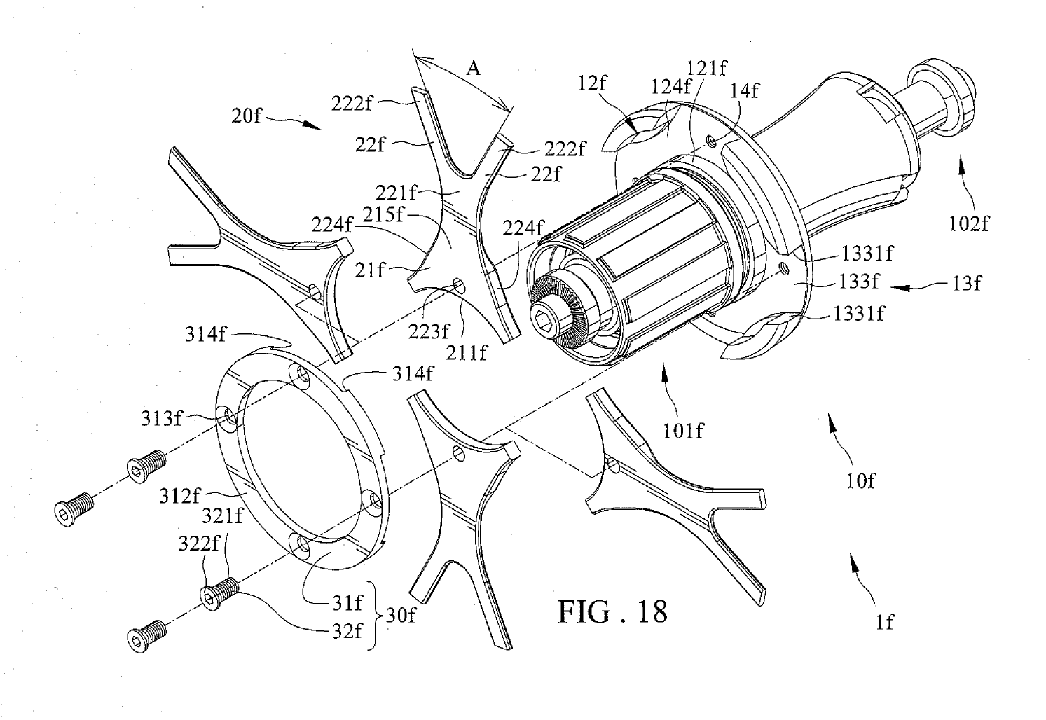

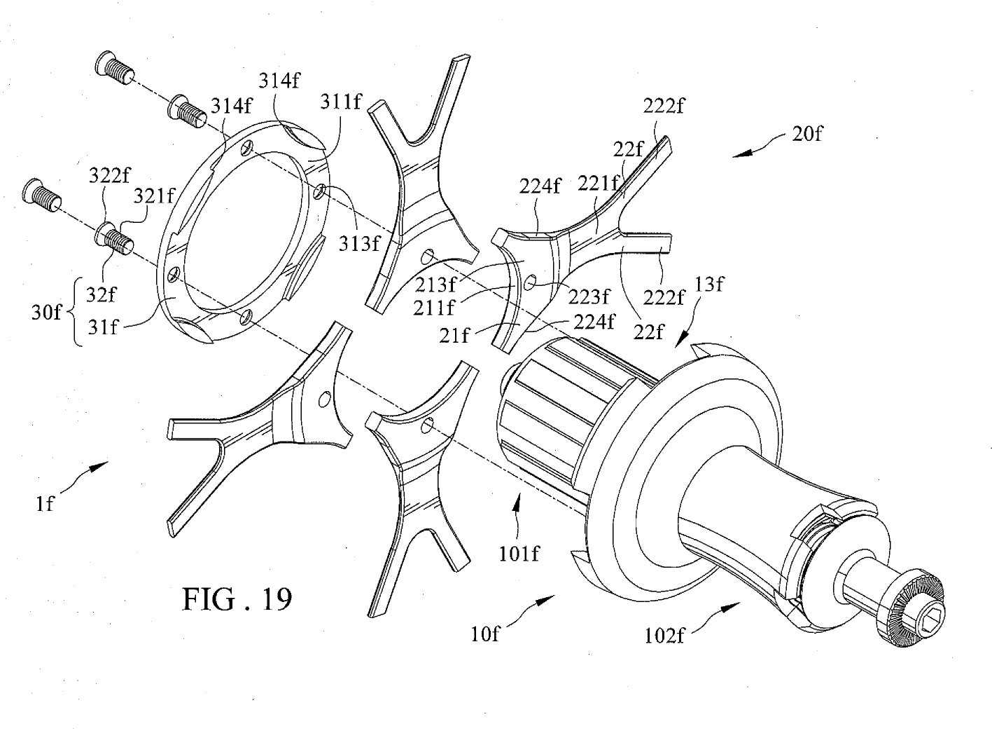

Referring to FIG. 17 to FIG. 19, there is shown a bicycle spoke and hub assembly 1f according to a sixth embodiment of the present invention. The sixth embodiment is like the first embodiment except that the bicycle spoke and hub assembly 1f comprises a plurality of connected device 20f and a locking device 30f. The seat 21f of each connected device 20f is substantially arched. Preferably, the seats 21f are abutted with each other and are installed to the installing portion 12f jointly. The first portion 221f of the spoke 22f has an aperture 223f formed therein. The bottom wall 124f of the installing portion 12f has a holding portion 14f formed thereon. The holding portion 14f corresponds to the aperture 223f. The holding portion 14f extends toward the second end 102f of the hub 10f and alone the longitudinal axis of the hub 10f The seat 21f has a proximal face 213f adjacent to the bottom wall 124f of the installing portion 12f. The locking device 30f includes a positioning element 31f and a fastener 32f. The positioning element 31f has a first face 311f adjacent to the bottom wall 124f of the installing portion 12f and a second face 312f opposite to the first face 311f. The first face 311f is parallel to the second face 312f. The positioning element 31f further includes a through hole 313f and two retaining walls 314f. The through hole 313f extends from the first face 311f to the second face 312f and corresponds to the holding portion 14f. The retaining walls 314f are formed on the first face 311f of the positioning element 31f and correspond to the edges 224f of the spoke 22f, respectively. Preferably, the holding portion 14f is a screw hole and the fastener 32f is a screw. The fastener 32f has a thread portion 321f on one end thereof and a flange 322f on the other end thereof distal from the thread portion 321f. The thread portion 321f corresponds to the holding portion 14f. The flange 322f is adapted for abutting the second face 312f of the positioning element 31f. Preferably, the connected device 20f has four apertures 223f, the installing portion 12f has four holding portions 14f corresponding to the four apertures 223f, and the locking device 30f has four fasteners 32f. The retaining wall 314f is perpendicular to the first face 311f. Each edge 224f abuts against the related retaining wall 314f so that the hub 10f can sustain the shear force applied thereon.

While the specific embodiments have been illustrated and described, numerous modifications come to mind without significantly departing from the spirit of invention, and the scope of invention is only limited by the scope of the accompanying claims.

What is claimed is:

1. A bicycle spoke and hub assembly comprising:
a hub having two opposing ends including a first end and a second end, wherein the first end of the hub has an installing portion, with the installing portion having an opening distal from the second end of the hub; and
a connected device including a seat and at least one spoke extended from the seat, wherein the seat and the spoke are made of one piece, with the seat of the connected device installed to the installing portion, wherein the spoke includes a first portion integrally formed on the seat and at least two second portions installed to a rim, with the second portions extended from the first portion, wherein the stress applied on the spoke is dissipated on the seat because the first portion is integrally formed on an outer surface of the seat, wherein stress concentration is not caused between the seat and the spoke.

2. The bicycle spoke and hub assembly as claimed in claim 1, wherein the installing portion includes a bottom wall, wherein the seat has a proximal face adjacent to the bottom wall of the installing portion and abutted against the bottom wall of the installing portion so as to prevent the seat from moving toward the second end of the hub.

3. The bicycle spoke and hub assembly as claimed in claim 1, wherein the first end of the hub includes a retaining portion formed thereon, wherein the retaining portion includes at least one recess, with the recess in communication with the installing portion, wherein the spoke inserts through the recess of the retaining portion and is retained via the recess.

4. The bicycle spoke and hub assembly as claimed in claim 1, wherein the installing portion includes a first inner wall, wherein the seat has a mounting portion, wherein the mounting portion is mounted on the first inner wall of the installing portion so as to prevent the seat from moving with respect to the hub.

5. The bicycle spoke and hub assembly as claimed in claim 4 further comprising a locking device, wherein the bottom wall of the installing portion has a holding portion formed thereon, wherein the locking device includes a positioning element and a fastener, wherein the positioning element has a first face adjacent to the bottom wall of the installing portion and a second face opposite to the first face, wherein the positioning element further includes a through hole, with the through hole extending from the first face to the second face and corresponding to the holding portion.

6. The bicycle spoke and hub assembly as claimed in claim 5, wherein the fastener has a thread portion on one end thereof and a flange on the other end thereof distal from the thread portion, wherein the thread portion corresponds to the holding portion, wherein the flange is adapted for abutting the second face of the positioning element.

7. The bicycle spoke and hub assembly as claimed in claim 1, wherein the installing portion includes a second inner wall, wherein the second inner wall of the installing portion is mounted on an outer surface of the seat, so as to prevent the seat from moving with respect to the hub.

8. The bicycle spoke and hub assembly as claimed in claim 7 further comprising a locking device installed to the first end of the hub, wherein the first end of the hub has a limiting portion formed thereon, wherein the seat has a proximal face adjacent to the bottom wall of the installing portion and abutted against the bottom wall of the installing portion so as to prevent the seat from moving toward the second end of the hub, wherein the seat further has a distal face distal from the proximal face, wherein the locking device includes a positioning element and a fastener, wherein the positioning element has a first face adjacent to the bottom wall of the installing portion, wherein the positioning element is installed to the limiting portion of the installing portion, wherein the first face of the positioning element abuts against the distal face of the seat so as to prevent the seat disengaging from the installing portion.

9. The bicycle spoke and hub assembly as claimed in claim 1 further comprising a locking device, wherein the first portion of the spoke has an aperture formed thereon, wherein the bottom wall of the installing portion has a holding portion formed thereon, with the holding portion corresponding to the aperture, wherein the locking device includes a fastener corresponding to the holding portion.

10. The bicycle spoke and hub assembly as claimed in claim 9, wherein the fastener has a thread portion on one end thereof and a flange on the other end thereof distal from the thread portion, with the thread portion corresponding to the holding portion, wherein the flange is adapted for abutting the first portion of the spoke.

11. The bicycle spoke and hub assembly as claimed in claim 3, wherein the recess has two lateral faces, wherein the spoke has two edges corresponding to the lateral faces respectively, with each edge abuts against the related lateral face so that the hub can sustain shear force applied thereon.

12. The bicycle spoke and hub assembly as claimed in claim 11, wherein the installing portion includes a bottom wall perpendicular to a longitudinal axis of the hub, with each lateral face perpendicular to the bottom wall.

13. The bicycle spoke and hub assembly as claimed in claim 5, wherein the spoke has two edges, wherein the positioning element includes two retaining walls, wherein the retaining walls are formed on the first face of the positioning element and correspond to the edges of the spoke, wherein each edge abuts against the related retaining wall so that the hub can sustain shear force applied thereon.

14. The bicycle spoke and hub assembly as claimed in claim 11, wherein the positioning element includes two retaining walls, wherein the retaining walls are formed on the first face of the positioning element and correspond to the edges of the spoke, wherein each edge abuts against the related retaining wall so that the hub can sustain shear force applied thereon.

15. The bicycle spoke and hub assembly as claimed in claim 1 further comprising a plurality of connected devices, wherein each connected device includes a seat and a spoke, wherein the spoke and the seat of each connected device are integrally formed.

16. The bicycle spoke and hub assembly as claimed in claim 15, wherein the seat of each connected device is arched.

17. The bicycle spoke and hub assembly as claimed in claim 15, wherein the seats are abutted with each other and are installed to the installing portion jointly.

18. The bicycle spoke and hub assembly as claimed in claim 1, wherein two of the second portions and the first portion have an angle, wherein each second portion is spaced from the other one, wherein the second portions dissipate the stress applied on the rim.

19. The bicycle spoke and hub assembly as claimed in claim 1, wherein each second portion and the first portion have a distance therebetween to keep the distance between the rim and the hub so that the smoothness of operating is improved.

20. The bicycle spoke and hub assembly as claimed in claim 1, wherein the connected device includes a plurality of spokes equally distributed on the outer surface of the seat, wherein all the spokes and the seat are integrally formed as a single to dissipate the stress applied on the seat.
